(19) United States
(12) Patent Application Publication
(10) Pub. No.: US 2005/0075829 A1
(43) Pub. Date: Apr. 7, 2005

(54) Vehicle usage tracking system and highway/city mileage odometer

(76) Inventor: James Polimadei, Rockville, MD (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/913,851

(22) Filed: Aug. 6, 2004

Related U.S. Application Data
(60) Provisional application No. 60/493,345, filed on Aug. 8, 2003.

(51) Int. Cl. G06F 15/00

(52) U.S. Cl. 702/165

(57) ABSTRACT

A vehicle odometer is provided that records highway mileage traveled by a vehicle. The odometer includes a sensor for selectively activating and deactivating the recording of distance traveled by the vehicle. The sensor may be a speed sensor that is connected to a city odometer and a highway odometer. The sensor activates the city odometer to record distance traveled below a predetermined speed on the city odometer, and deactivates the highway odometer below the predetermined speed. The sensor deactivates the city odometer and activates the highway odometer at speeds above the predetermined speed to record the distance traveled above the predetermined speed on the highway odometer.

This application claims priority to co-pending U.S. Provisional Patent Application Ser. No. 60/493,345, filed Aug. 8, 2003, the entire disclosure of which is incorporated herein by reference.

### FIELD OF THE INVENTION

The present invention generally relates to methods and systems for measuring distances traveled by a vehicle and tracking usage of the vehicle. More specifically, the present invention generally relates to methods and systems for measuring the distance traveled by a vehicle during certain predetermined vehicle status conditions, such as when the vehicle is moving at certain speeds or after a service warning has been displayed.

### BACKGROUND

In conventional systems, many vehicles have included an odometer, which records the total number of miles driven by that vehicle. Some vehicles also have trip odometers which record a total number of miles driven for a specific length of time and can be reset by the vehicle operator. Regardless of whether the odometer is a trip odometer that can be reset by the vehicle operator, or a standard odometer that permanently records the total miles traveled by the vehicle, conventional vehicle odometers are designed to continuously record the distance traveled by the vehicle between two given points. They typically do not permit intermittent recordation of distance. Nevertheless, vehicle operators often utilize estimates of intermittent distances traveled to evaluate vehicle usage. For example, vehicle operators often refer to a vehicle's mileage as being primarily highway miles. Yet, conventional odometers do not provide a means for operators to accurately measure such mileage. Therefore, it is desirable to provide a vehicle odometer that overcomes these and related problems.

### SUMMARY

Methods and systems in accordance with the present invention record the distance traveled by a vehicle during a predetermined condition such as while the vehicle is traveling at highway speeds. They may provide a vehicle odometer or distance measurement device that includes a sensor to activate and deactivate the recordation of distance by the odometer upon detection of a predetermined condition such as traveling above a certain predetermined speed.

In one implementation, a vehicle odometer is provided comprising a vehicle status sensor. The vehicle odometer further comprises a distance measurement device configured to record a distance traveled by a vehicle upon detection of a predetermined condition by the status sensor.

In another implementation, a method of monitoring vehicle usage is provided comprising the steps of sensing a predetermined vehicle status condition of a vehicle, and obtaining a distance traveled by the vehicle during the status condition.

In yet another implementation, a method of monitoring vehicle usage is provided comprising the steps of determining whether a vehicle is moving over a predetermined speed, and recording distance traveled over the predetermined speed based on the determination.

### BRIEF DESCRIPTION OF THE DRAWINGS

Embodiments in accordance with methods and systems consistent with the present invention are set forth in the following description and are shown in the drawings.

FIG. 1 shows an exemplary dashboard with a multiple-display embodiment of the highway/city odometer in accordance with methods and systems consistent with the present invention.

FIG. 2 is a diagram showing a highway/city odometer embodiment in accordance with methods and systems consistent with the present invention.

FIG. 3 is a flow diagram showing an exemplary method for the operation of a highway/city odometer embodiment in accordance with methods and systems consistent with the present invention.

FIG. 4 is a flow diagram showing an exemplary method for the operation of a service warning odometer embodiment in accordance with methods and systems consistent with the present invention.

### DETAILED DESCRIPTION

Methods and systems in accordance with the present invention record the distance traveled by a vehicle during a predetermined condition such as while the vehicle is traveling at highway speeds. They may record distance traveled during a predetermined condition as traveling above a certain predetermined speed. In this manner, they may record, for example, highway mileage for a vehicle.

In one embodiment, the predetermined condition in which distance is recorded by the odometer is a specified speed range in which the vehicle is traveling, or above or below a speed threshold. In one embodiment, multiple distance measurement devices are combined together to provide distances traveled by the vehicle within several ranges of speed. For example, in an exemplary highway/city mileage odometer, one distance measurement device will measure the “city” distance traveled between zero and forty-five miles per hour, and a second distance measurement device will measure the “highway” distance traveled above forty-five miles per hour. A third odometer can also be included to measure the total distance traveled by the vehicle. A speed sensor will activate the city odometer when the speed is detected to be between one and forty-five miles per hour. When the speed is detected to be above forty-five miles per hour the speed sensor will deactivate the city odometer and activate the highway odometer. In alternative embodiments in which the distance measurement device is activated and deactivated within a specified speed range of the vehicle, additional odometers can be utilized to provide distance measurement for any number of desired speed ranges (i.e., 1-10 mph, 11-20 mph, 21-30 mph, etc.). This allows an even more comprehensive understanding of how a vehicle was driven, including rapid acceleration and speeding.

In another embodiment in accordance with the present invention, the predetermined condition in which distance is recorded by the odometer is a vehicle service warning to the vehicle operator. Once a service warning is displayed, the sensor will activate the distance measurement device to record distance traveled by the vehicle. One benefit of this feature is that manufacturers can be more informed on how a vehicle was driven and for how long once service was needed. This will aid in dealing with warranty related service.

In yet another embodiment in accordance with the present invention, the odometer can be selectively activated and deactivated by the vehicle operator to record any distances deemed useful to the operator. For example, if a vehicle is being driven on a long trip, the operator may desire to measure distances traveled on two-lane highways versus distances traveled on four-lane highways. Thus, the operator could activate the odometer when starting on a two-lane highway, then deactivate whenever a four-lane highway is traveled, and reactivate at the next two-lane highway. In this manner the odometer would cumulatively record the entire distance traveled on two-lane highways during the trip. Other predetermined conditions may also be used.

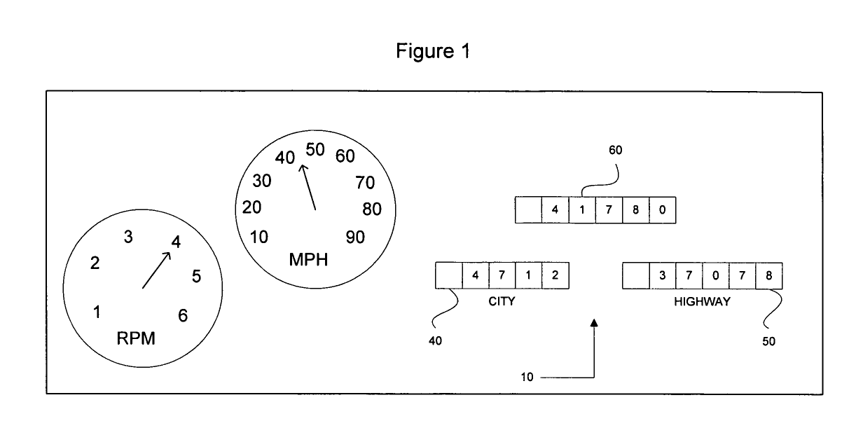

FIG. 1 shows an exemplary dashboard with a multiple-display embodiment of the highway/city odometer in accordance with methods and systems consistent with the present invention. As is shown in FIG. 1, the highway and city mileage odometer 10, includes three separate displays in the dashboard of the vehicle in which it is located; display 50 for highway mileage, display 40 for city mileage, and display 60 for total mileage. The displays can be rolling number, digital, or any other display, the constructions of which may be known. As there may already be both rolling number and digital odometers, methods and systems in accordance with the present invention improve upon the types of information that an odometer records.

The highway/city mileage odometer may function similarly to the other two types of known odometers (i.e., total mileage odometers and trip odometers) in that it will record a total number of miles driven by a vehicle. The highway/city mileage odometer may record the number of both highway and city miles driven by a vehicle. In one embodiment, the odometer records both highway and city miles. Alternative embodiments selectively record either highway miles or city miles. As a vehicle begins moving, the city mileage odometer 40 will begin recording the number of miles driven. Once the vehicle reaches a certain predetermined speed (for example, the number of miles per hour a vehicle must be traveling to be deemed “highway miles”), a sensor mechanism 30 detects that the vehicle speed has reached this critical speed, and triggers the city mileage odometer 40 to stop recording the mileage and triggers the highway mileage odometer 50 to begin recording the mileage. The highway mileage odometer 50 continues to record the mileage for the vehicle driving at the predetermined speed and speeds above that number until the vehicle speed drops below the predetermined speed. Once this occurs, the city mileage odometer 40 will resume recording the mileage. For example, a vehicle begins driving from a stopped position and the city mileage odometer 40 begins recording the miles driven. Assume that 45 miles per hour is deemed the predetermined speed that will trigger the highway mileage odometer 50. The vehicle reaches a speed of 45 miles per hour, the city mileage odometer 40 stops recording the miles driven, and the highway mileage odometer 50 is activated to begin recording miles. The highway mileage odometer 50 continues to record mileage until the vehicle speed falls below 45 miles per hour. At this point, the city mileage odometer 40 resumes recording mileage. The sum of the city and highway mileage will equal the total number of miles on the vehicle's total mileage odometer 60. In one embodiment, the highway/city mileage odometer 10, like conventional total mileage odometers, is a permanent recording device in the vehicle and should not be tampered with to alter the true distance measurements.

The highway/city mileage odometer 10 may operate similarly to other odometers, including both rolling number odometers and digital odometers, and is useful in many different types of vehicles (e.g., cars, trucks, military vehicles, aircraft, motorcycles, race vehicles, spacecraft, or any other type of vehicle, device or component). Where rolling number odometers are utilized, one embodiment features side-by-side city 40 and highway 50 mileage odometers below the total mileage odometer 60, each being labeled appropriately. In an alternative embodiment in which a digital odometer is utilized, a single display screen can be utilized in combination with a toggle switch that allows the vehicle operator to toggle between the three readings (total, city, and highway mileage). In another embodiment, the highway and city miles are monitored and recorded via GPS tracking devices, which are now common in many vehicles. The odometers may be constructed in a manner similar to conventional odometers and distance measuring systems such as those disclosed in U.S. Pat. Nos. 4,682,287, 6,088,636, 5,267,159, 4,970,377, 4,975,564, 5,162,637, and 5,475,724, which are incorporated herein by reference.

Methods and systems in accordance with the present invention may be implemented in many different ways. Distance measuring may be performed and tracked by many different components. Odometer functions and distance measuring may be performed by any component, and these components may not have the appearance of a traditional odometer. For example, in one implementation, a traditional odometer display may not be used whereas mileage may be tracked and stored on a computer chip for the use of service technicians or other personnel. In other implementations, methods and systems in accordance with the present invention may be performed by, for example, navigation systems, trip computers, other computers, devices, satellite-based systems, etc. Any of these or any other type of system may be used. In a satellite-based system, distance tracking could be done in conjunction with a GPS system or any other suitable system. Tracking devices may be installed in the vehicle and communicate with a satellite system to implement methods and systems in accordance with the present invention.

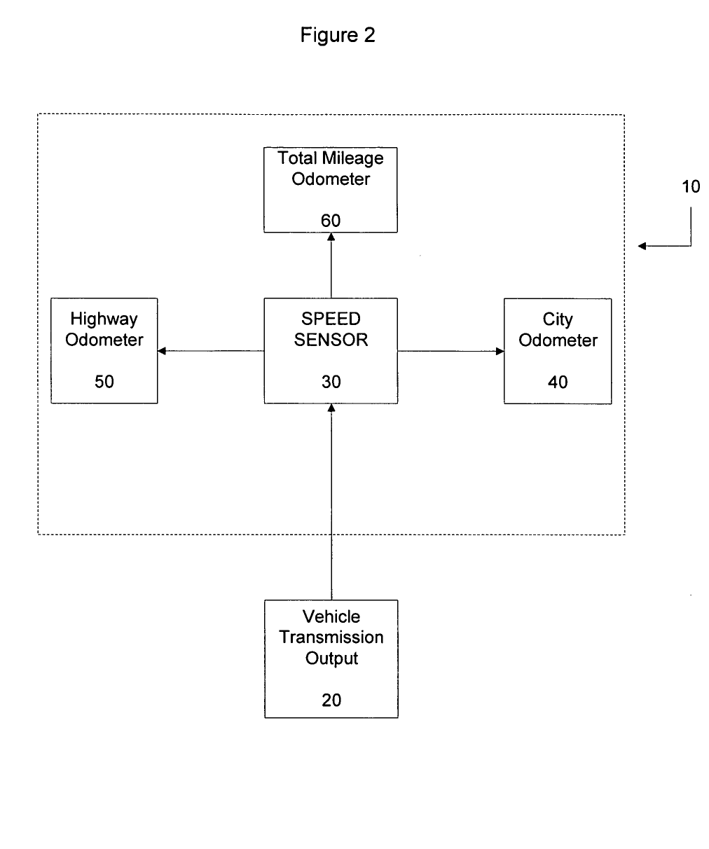

FIG. 2 is a diagram showing a highway/city odometer embodiment in accordance with methods and systems consistent with the present invention. FIG. 2 shows an exemplary embodiment in which the highway/city odometer 10 is connected to the output shaft 20 of a vehicle transmission. It will be appreciated that the connection of odometer 10 to output shaft 20 of the vehicle transmission can be accomplished in any manner presently known or hereafter developed. In an exemplary embodiment shown in FIG. 2, speed sensor 30 may be an electronic component that measures the speed of rotation of transmission shaft 20 in a manner known for use with digital speedometers. Nevertheless, it will be appreciated that speed sensor 30 could be a mechanical mechanism constructed in a manner similar to that of mechanical speedometers. In such an embodiment, clutches, solenoids or other similar mechanical or electro-mechanical devices (or a combination of such devices) can be utilized to selectively activate and deactivate the mechanical highway odometer 50 and city odometer 40. In addition, although shown as a single sensor, it will be appreciated that speed sensor 30 can be constructed as multiple sensors (e.g., electric or mechanical) each independently connecting vehicle output shaft 20 to one of the odometers (i.e., one sensor connected to city odometer 40, and a separate sensor connected to highway odometer 50). Furthermore, it is understood that the speed sensor can be incorporated into and be a part of the engine control unit (“ECU”) for the vehicle, which can also include the distance measurement devices that are activated and deactivated by the speed sensor. In such event, the distance measurement devices may comprise memory locations within the ECU for storing distances that are provided by the speed sensor (or based upon data provided by the speed sensor), and the odometer will include a digital display screen for displaying the recorded distances.

As is shown in FIG. 2, speed sensor 30 measures the speed the vehicle is traveling via transmission output shaft 20 for the vehicle. The speed sensor, a computer connected to or associated with the speed sensor, or an ECU of which speed sensor 30 is a component (collectively and generally referred to herein as “speed sensor 30”), is connected to total mileage odometer 60 to record the total mileage of the vehicle. This recordation may be a permanent recordation. This may be accomplished in the manner already known in the art of computerized and/or digital odometers. Speed sensor 30 is also connected to city odometer 40 and highway odometer 50.

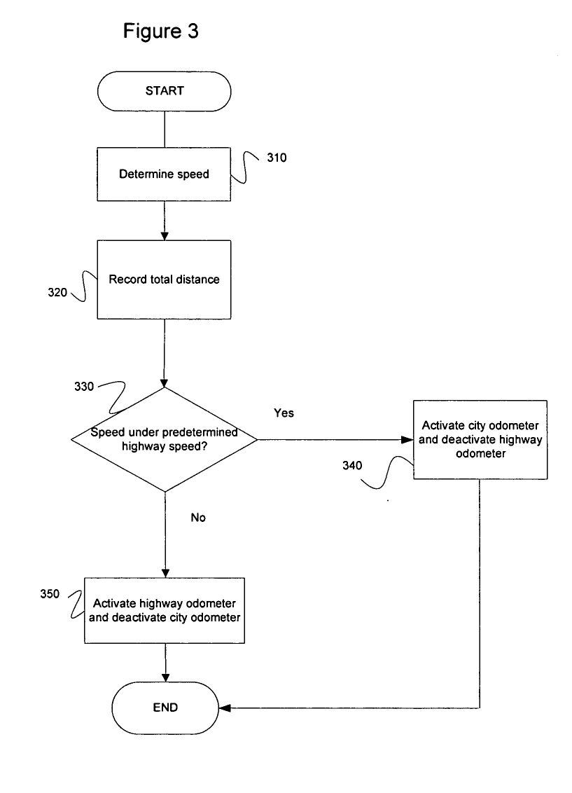

FIG. 3 is a flow diagram showing an exemplary method for the operation of a highway/city odometer embodiment in accordance with methods and systems consistent with the present invention. As is shown in FIG. 3, speed sensor 30 selectively activates either city odometer 40 or highway odometer 50 to record the distance traveled by the vehicle. Speed sensor 30 determines the speed of the vehicle (step 310) and the total distance traveled by the vehicle is recorded by total distance odometer 60 (step 320). Speed sensor 30 determines whether the vehicle is traveling below a predetermined highway speed (step 330). If the vehicle is traveling below the predetermined highway speed, speed sensor 30 activates city odometer 40 to record the distance being traveled, and highway odometer 50 is deactivated (step 340). If the vehicle is not traveling below the predetermined highway speed, the speed sensor activates highway odometer 50 to record the distance being traveled and city odometer 40 is deactivated (step 350).

There are multiple benefits to tracking a vehicle's highway and city mileage. Vehicle maintenance is one advantage. Manufacturers can recommend different and more specific service and service schedules for vehicles with higher highway miles or higher city miles. Knowing how a vehicle is being driven, either highway or city driving, could aid service technicians to better determine the service needed for individual vehicles. They can also monitor the wear-and-tear of vehicle parts, such as drive belts, to determine if the design of parts could be improved upon. Service technicians could also be protected against falsified information from customers when dealing with service regarding how the vehicle is driven (e.g., highway or city miles, driving habits of the vehicle operator). In addition, customers that regularly have their vehicle serviced at the same place could have a more complete understanding of their vehicle history since service technicians could monitor the vehicle operator's driving habits over the history of the vehicle.

Another advantage includes knowing the vehicle's history. When buying or selling a used vehicle, the purchaser could utilize the odometer reading to determine the value of a vehicle. The may be done in conjunction with vehicle information companies such as Carfax or Kelly Blue Book. The highway/city mileage odometer provides a more comprehensive understanding about how a vehicle has been driven, impacting the potential value of a used vehicle. Greater highway mileage on a vehicle typically results in higher resale of the vehicle. Likewise, higher city mileage on a vehicle typically results in lower resale value of the vehicle. Potential buyers of used vehicles conventionally have had no way of truly knowing if a vehicle has been mainly highway or city driven. When selling a used vehicle, higher highway/lower city mileage may be a selling point for a vehicle. Methods and systems in accordance with the present invention may have a computer that monitors the history of the vehicle's maintenance. Maintenance records and related information may be stored on a memory or computer chip in the vehicle.

Rental vehicle companies may also benefit from highway/city mileage odometers. Highway/city mileage odometers in rental vehicles would enable such companies (such as Hertz, Budget, U-Haul, etc.) to charge their customers according to the type of driving done in the vehicle, specifically the percentage of highway versus city miles driven. A vehicle driven with higher city miles could require a more rapid service schedule that would cost the rental company more money in maintenance. Therefore, the rental company could charge the customer a premium rate for city miles or offer a discount for highway miles. In addition, companies that have a fleet of vehicles for commercial use (such as FedEx, Verizon, US Post Office, etc.) could better monitor the driving habits of their employees and the service of the vehicle.

Furthermore, other advantages may be realized. Drivers can more accurately track the number of miles per gallon of gasoline (fuel efficiency) in a vehicle if they are aware of their highway and city mileage. Driving enthusiasts would have the ability to monitor their driving habits and could pay closer attention to their driving style, especially if their goal was to keep their vehicle in peak resale condition (for example, vintage and exotic vehicle owners). Additionally, inexperienced drivers may be monitored. Parents may easily check if their children (especially new and inexperienced drivers) were driving above the predetermined speed for highway miles. For example, if a parent did not want their child driving on a highway or on roads where the speed limit was above the predetermined speed for highway miles, the parent could check the highway/city mileage odometer to monitor their child's driving habits.

It will be appreciated that the predetermined speed ranges in which the city and highway odometers can be preset or preprogrammed at the factory. In one embodiment, where it is desired to maintain a permanent and unaltered record of highway miles, the predetermined speed will be preset and not capable of being reprogrammed by the driver. In alternative embodiments, however, such as where it is desired to monitor fuel efficiency or other driving habits, the desired speed ranges in which distance traveled is to be recorded may be selectively programmed by the driver. In addition, in such embodiments where vehicle performance or maintenance is being monitored (as opposed to tracking highway mileage for resale value), it may be desirable to allow the distance recorded to be reset to zero by the driver.

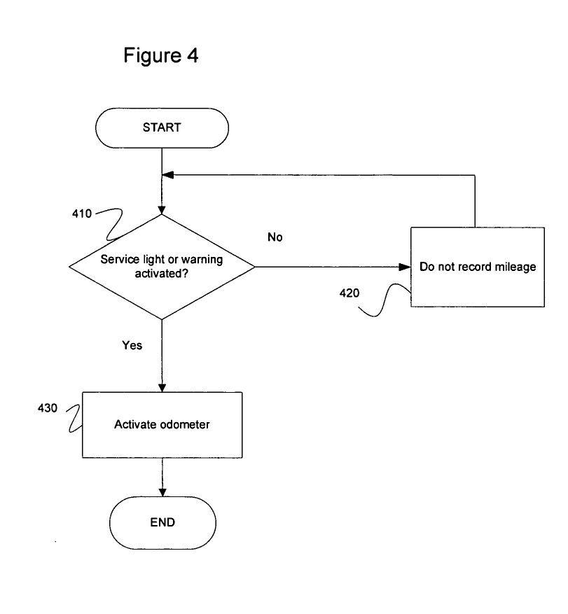

FIG. 4 shows an alternative embodiment in which an odometer is activated to record a distance traveled after the operator has been notified of a service warning. In FIG. 4, a sensor monitors whether a service light or warning has been activated by the vehicle engine control unit (step 410.) If a service light is not activated, the odometer is deactivated, and no mileage is recorded (step 420.) Monitoring of the service light or warning may continue if a service light is activated, the odometer is activated by the sensor and the distance traveled by the vehicle is recorded (step 430.) It will be appreciated that, although the sensor is described above separate from the engine control unit, the sensor can be a part of the engine control unit. In addition, although referenced as a sensor, it is understood, that the engine control unit itself (or any other component) can be used to activate the odometer simultaneously as the service warning light is activated. In such event, the engine control unit will not require a separate “sensor” to determine that the light has been activated, as the engine control unit itself acts directly as the sensor, which detects the predetermined condition (i.e., the engine malfunction) that requires activation of the odometer.

Although the foregoing detailed description has been described by reference to an exemplary embodiment, it will be understood that certain changes, modification or variations may be made other than those specifically set forth herein, may be achieved by those skilled in the art without departing from the spirit and scope in accordance with the present invention, and that such changes, modification or variations are to be considered as being within the overall scope. Therefore, it is contemplated to cover any and all changes, modifications, variations, or equivalents that fall with in the true spirit and scope of the underlying principles disclosed.

1. A vehicle odometer comprising:
a vehicle status sensor; and
a distance measurement device configured to record a distance traveled by a vehicle upon detection of a predetermined condition by the status sensor.

2. The vehicle odometer of claim 1 wherein the status sensor comprises a speed sensor and the predetermined condition comprises movement of said vehicle within a specified speed range.

3. The vehicle odometer of claim 1 wherein the status sensor comprises a speed sensor and the predetermined condition comprises movement of the vehicle over a predetermined speed.

4. The vehicle odometer of claim 1 wherein the status sensor comprises a speed sensor and the predetermined condition comprises movement of the vehicle under a predetermined speed.

5. The vehicle odometer as claimed in claim 1 wherein the predetermined condition comprises a vehicle service warning.

6. The vehicle odometer of claim 2 further comprising a second distance measurement device configured to record a distance traveled by the vehicle within a second speed range.

7. The vehicle odometer of claim 6 wherein the specified speed range is approximately between one and forty-five miles per hour and the second speed range is approximately between forty-five miles per hour and above.

8. The vehicle odometer of claim 6 wherein the distance measurement device and the second distance measurement device comprise a single selectable display on a dashboard of the vehicle.

9. The vehicle odometer of claim 6 wherein the distance measurement device and the second distance measurement device each comprise a separate display on a dashboard of the vehicle.

10. The vehicle odometer of claim 1 wherein the status sensor comprises an electronic switch for activating the distance measurement device.

11. The vehicle odometer of claim 1 wherein the status sensor comprises a mechanical switch for activating the distance measurement device.

12. The vehicle odometer of claim 1 further comprising a second distance measurement device to record a total distance traveled by the vehicle.

13. The vehicle odometer of claim 1 wherein the distance measurement device provides a permanent record of distance traveled by the vehicle during the predetermined condition.

14. The vehicle odometer of claim 1 wherein the distance measurement device comprises a rolling number odometer.

15. The vehicle odometer of claim 1 wherein the distance measurement device comprises a digital odometer.

16. The vehicle odometer of claim 1 wherein the distance measurement device comprises a GPS.

17. The vehicle odometer of claim 6 further comprising a third distance measurement device connected to the speed sensor, the third distance measurement device configured to record a distance traveled by the vehicle within a third speed range.

18. A method of monitoring vehicle usage comprising the steps of:
sensing a predetermined vehicle status condition of a vehicle; and
obtaining a distance traveled by the vehicle during the status condition.

19. The method of claim 18 wherein the status condition comprises movement of the vehicle over a predetermined speed.

20. The method of claim 18 wherein the status condition comprises movement of the vehicle under a predetermined speed.

21. The method of claim 19 wherein the predetermined speed is forty-five miles per hour.

22. The method of claim 18 wherein the status condition comprises movement of the vehicle within a specified speed range.

23. The method of claim 18 wherein the status condition comprises a vehicle service warning.

24. The method of claim 18 further comprising the step of evaluating the distance traveled of the vehicle.

25. The method as claimed in claim 22 wherein said evaluating step comprises the step of determining a vehicle maintenance schedule.

26. The method of claim 22 wherein the evaluating step comprises the step of determining a value for the vehicle.

27. The method of claim 22 wherein the evaluating step comprises the step of determining a rental charge for the vehicle.

28. The method of claim 22 wherein the evaluating step comprises the step of determining operator driving habits.

29. A method of monitoring vehicle usage comprising the steps of:
determining whether a vehicle is moving over a predetermined speed; and
recording distance traveled over the predetermined speed based on the determination.
